(19) United States
(12) Patent Application Publication
(10) Pub. No.: US 2007/0196637 A1
(43) Pub. Date: Aug. 23, 2007

(54) Fiber-reinforced thermoplastic composite material

(76) Inventors: Brian Timothy Good, Forest, VA (US); Thomas Arnold Ebeling, Forest, VA (US); Daniel Scott Woodman, Lynchburg, VA (US); John Joseph McHugh, Greenville, SC (US); Huda Abdul Jerri, State College, PA (US); Peter Liam Wallace, Newlyn (GB)

Correspondence Address: MARK L. WARZEL, 10252 OVERHILL DRIVE, SANTA ANA, CA, 92705, US

(21) Appl. No.: 11/645,979

(22) Filed: Dec. 26, 2006

Related U.S. Application Data
(60) Provisional application No. 60/755,840, filed on Jan. 3, 2006.

(51) Int. Cl. B32B 27/04; B32B 3/26

(52) U.S. Cl. 428/297.4; 428/304.4

(57) ABSTRACT

A composite material is provided in which certain properties, or combinations of properties, are improved relative to similar comparative composite materials. The composite material generally comprises a fiber reinforced thermoplastic core that includes a thermoplastic resin and discontinuous fibers dispersed within the thermoplastic resin. The fibers are particularly subject to certain conditions, namely a content of about 15 wt. % to about 65 wt. % of the thermoplastic core, a diameter of from about 17 μm to about 22 μm, and a length of from about 17 mm to about 25 mm. By including fibers meeting these characteristics, the present invention composite material exhibits improved maximum flexural stiffness at reduced basis weight compared to a comparative composite material comprising a fiber reinforced thermoplastic core differing from the composite material only in that the fiber reinforced thermoplastic core of the comparative composite material does not contain fibers meeting the content, diameter and length conditions of the fibers in the thermoplastic core of the composite material.

### CROSS REFERENCE TO RELATED APPLICATIONS

This application claims priority under 35 U.S.C. §119(e)(1) to U.S. Provisional Application No. 60/755,840, filed Jan. 3, 2006, which is hereby incorporated by reference in its entirety.

### FIELD OF THE INVENTION

The present invention relates to fiber reinforced thermoplastic composite materials, the use of such materials to form moldable articles, and to improvements in certain characteristics. More particularly, the invention relates to fiber-reinforced composite materials having a beneficial combination of characteristics wherein the composite material exhibits improved flexural properties, while maintaining other desirable properties. Although not limited thereto, the invention is useful in the manufacture of building infrastructure, construction, and automotive articles, such as headliners, door modules, instrument panel toppers, front and/or rear pillar trims, sunshades, parcel shelves, side wall panels, such as for recreational vehicles, and package trays, in construction articles, such as ceiling panels, cargo liners and office partitions, and other such applications that are currently made with polyurethane foam, polyester fiber filled multi-layered composites, and thermoplastic sheets, in which the improved flexural characteristics provide advantages over other materials utilized for such applications.

### BACKGROUND OF THE INVENTION

Driven by a growing demand by industry, governmental regulatory agencies and consumers for durable and inexpensive products that are functionally comparable or superior to metal products, a continuing need exists for improvements in composite articles subjected to difficult service conditions. This is particularly true in the automotive industry where developers and manufacturers of articles for automotive and construction materials applications must meet a number of competing and stringent performance specifications for such articles.

In an effort to address these demands, a number of composite materials have been developed, including glass fiber reinforced thermoplastic composites. Such composites provide a number of advantages, e.g., they can be molded and formed into a variety of suitable products both structural and non-structural, including, among many others, automotive bumpers, interior headliners, and interior and exterior trim parts. Traditional glass fiber composites used in exterior structural applications are generally compression flow molded and are substantially void free in their final part shape. By comparison, low density glass fiber composites used in automotive interior applications are generally semi-structural in nature and are porous and light weight with densities ranging from 0.1 to 1.8 g/cm³ and containing 5% to 95% voids distributed uniformly through the thickness of the finished part. The stringent requirements for certain automotive interior applications have been difficult to meet, however, for existing glass fiber composite products, particularly where such applications require a desirable combination of properties, such as light weight, good flexural properties or rigidity and good strength characteristics. As a result, a continuing need exists to provide further improvements in the ability of composite materials to meet such performance standards.

Porous fiber reinforced thermoplastic sheets have been described in U.S. Pat. Nos. 4,978,489 and 4,670,331 and are used in numerous and varied applications in the product manufacturing industry because of the ease of molding the fiber reinforced thermoplastic sheets into articles. Known techniques, for example, thermo-stamping, compression molding, and thermoforming have been used to successfully form articles from fiber reinforced thermoplastic sheets.

In some industries, for example, the automotive industry, a need also exists for products formed from porous fiber reinforced thermoplastic sheets that have higher flexural properties than known products. In automotive headliner and sunshade substrate applications, for example, the balance of weight and part stiffness is an important concern due to the desire to minimize weight while maintaining the stiffness required for the part application. The ability to achieve improved part stiffness at reduced basis weight would consequently provide a significant advantage over fiber reinforced thermoplastic composite materials currently in use.

### BRIEF DESCRIPTION OF THE INVENTION

Accordingly, in one aspect of the invention, a composite material is provided in which certain properties, or combinations of properties, are improved relative to similar comparative composite materials. The composite material generally comprises a fiber reinforced thermoplastic core that includes a thermoplastic resin and discontinuous fibers dispersed within the thermoplastic resin. The fibers are particularly subject to certain conditions, namely a content of about 15 wt. % to about 65 wt. % of the thermoplastic core, a diameter of from about 17 μm to about 22 μm, and a length of from about 17 mm to about 25 mm. By including fibers meeting these characteristics, the present invention composite material exhibits improved maximum flexural stiffness at reduced basis weight compared to a comparative composite material comprising a fiber reinforced thermoplastic core differing from the composite material only in that the fiber reinforced thermoplastic core of the comparative composite material does not contain fibers meeting the content, diameter and length conditions of the fibers in the thermoplastic core of the composite material.

In another aspect of the invention, a method of providing a composite material having an improved combination of flexural stiffness, peak load, offset yield, and loft properties in a composite thermoplastic sheet material is described. The method includes adding reinforcing fibers and thermoplastic resin to an agitated liquid-containing foam to form a dispersed mixture of thermoplastic resin and reinforcing fibers, wherein the fiber content is from about 15 wt. % to about 65 wt. % of the composite material, and the fibers have a diameter of from about 17 μm to about 22 μm, and a length of from about 17 mm to about 25 mm; coating the dispersed mixture of reinforcing fibers and thermoplastic resin onto a forming support element; evacuating the liquid to form a web; heating the web above the softening temperature of the thermoplastic resin; and compressing the web to a predetermined thickness to form the composite material. The method provides a composite material exhibiting improved maximum flexural stiffness at reduced basis weight compared to a comparative composite material comprising a fiber reinforced thermoplastic core differing from the composite material only in that the fiber reinforced thermoplastic core of the comparative composite material does not contain fibers meeting all of the content, diameter and length conditions of the fibers in the thermoplastic core of the composite material.

### BRIEF DESCRIPTION OF THE DRAWINGS

FIG. 1 shows a sectional view of a composite material in sheet form in accordance with one aspect of the invention.

FIGS. 2-7 depict calculated flexural properties (contour plots) obtained from experimental results as described in Example 1 and comparative Example 1A.

FIG. 8 depicts the calculated geomean maximum stiffness as described in the Experimental section.

### DETAILED DESCRIPTION OF THE INVENTION

As used in the specification and the appended claims, the singular forms “a,” “an,” and “the” include plural referents unless the context clearly dictates otherwise. Thus, for example, reference to “a thermoplastic resin” encompasses a combination or mixture of different resins as well as a single resin, reference to “a skin layer” or “a surface layer” includes a single layer as well as two or more layers that may or may not be the same and may be on one or more sides or surfaces of the composite material, and the like.

As used herein, the term “about” is intended to permit some variation in the precise numerical values or ranges specified. While the amount of the variation may depend on the particular parameter, as used herein, the percentage of the variation is typically no more than 5%, more particularly 3%, and still more particularly 1% of the numerical values or ranges specified.

In this specification and in the claims that follow, reference will be made to a certain terms, which shall be defined to have the following meanings:

The term “basis weight” generally refers to the areal density of a fiber reinforced thermoplastic material, typically expressed in grams per square meter (g/m² or gsm) of the material in sheet form. The term “reduced basis weight” refers to a reduction in the basis weight that may be realized for composite materials according to the invention relative to a comparative composite material. As used herein, the “comparative composite material” differs from the inventive material in one or more of the characteristics of the fibers incorporated into the thermoplastic resin forming the thermoplastic core.

The term “flexural stiffness” refers to the conventional measure of the resistance of a material to deformation under load, typically measured according to standard test procedures. Flexural testing was performed according to a Honda Motor Co. test procedure to determine the flexural peak load and slope (modulus) by subjecting samples to a three-point bending test (as described in greater detail in the Experimental section). Flexural stiffness is typically expressed herein in units of N/mm or N/cm. The term “maximum flexural stiffness” refers to the maximum value calculated based on flexural testing results as described in the Examples.

The terms “flexural peak load strength”, “peak load strength”, “flexural peak load”, “peak load” refer to results obtained according to the same Honda Motor Co. flexural test procedure noted herein and are the peak load conditions measured during flexural testing.

The terms “yield offset” and “yield offset strength” have the same meaning and refer to the conventional usage of these terms, namely the stress at which the strain surpasses by a specific amount (called the offset) an extension of the initial proportional portion of the stress-strain curve.

In general, the composite material of the invention includes a thermoplastic resin and discontinuous fibers dispersed within the thermoplastic resin. One or more skin layers may also be included on the surface of the fiber-containing thermoplastic resin. The discontinuous fibers dispersed within the thermoplastic resin satisfying the following conditions: a content of about 15 wt. % to about 65 wt. % of the thermoplastic core, a diameter of from about 17 μm to about 22 μm, and a length of from about 17 mm to about 25 mm. As demonstrated in the Examples, by including fibers meeting these characteristics, the present invention composite material exhibits improved maximum flexural stiffness at reduced basis weight compared to a comparative composite material comprising a fiber reinforced thermoplastic core differing from the composite material only in that the fiber reinforced thermoplastic core of the comparative composite material does not contain fibers meeting the content, diameter and length conditions of the fibers in the thermoplastic core of the composite material.

In other aspects of the invention, the maximum flexural stiffness of the composite material is at least about 20% greater than the comparative composite material, more particularly at least about 25% greater than the comparative composite material, still more particularly at least about 30% greater than the comparative composite material, and most particularly at least about 35% greater than the comparative composite material.

Although the flexural stiffness advantages realized by the invention may be obtained at reduced basis weight, the invention also includes the aspect wherein the basis weight of the composite material is about the same as the comparative composite material described herein. Nonetheless, in some aspects of the invention, the reduced basis weight of the composite material may be advantageously at least about 10% less than th e comparative composite material described herein, more particularly at least about 15% less than the comparative composite material, still more particularly at least about 18% less than the comparative composite material.

In further aspects of the invention, the composite material demonstrates additional advantageous properties relative to the comparative composite material, including flexural peak load and/or yield offset values that are about the same as or greater than the comparative composite material. While these characteristics may also be realized at reduced basis, as described above for the flexural stiffness, the basis weight of the inventive composite material may also be about the same as the comparative composite material described herein. In alternate aspects, the flexural peak load and/or yield offset values described above may be realized at a reduced basis weight of the composite material that is at least about 10% less than the comparative composite material described herein, more particularly at least about 15% less than the comparative composite material, still more particularly at least about 18% less than the comparative composite material.

As described herein, the composite material may be non-porous or porous. Advantageously, the thermoplastic core has a porosity between about 0% to about 95% by volume of the thermoplastic core, more particularly between about 30% to about 80% by volume of the thermoplastic core. While not required, it is also possible that the composite material, which includes the thermoplastic core, is non-porous or has a porosity within the aforementioned ranges; i.e., the porosity of the composite material may vary between about 0% and about 95%, more particularly between about 30% and about 80% of the total volume of the composite material.

The thermoplastic resin may generally be any thermoplastic resin having a melt temperature below the resin degradation temperature. Non-limiting examples of such resins include polyolefins such as polyethylene and polypropylene, thermoplastic polyolefin blends, polyvinyl chloride, butadiene polymers, polyamides, polyesters (e.g., PET, PBT, and polypropyleneterephthalate), polycarbonates, polyestercarbonates, polystyrenes, acrylonitrylstyrene polymers, acrylonitrile-butylacrylate-styrene polymers, acrylics, including polymethyl methacrylate, polyether imide, polyphenylene ether, polyphenylene oxide and copolymers or mixtures thereof. Other thermoplastic resins can be used that can be sufficiently softened by heat to permit fusing and/or molding without being chemically or thermally decomposed during processing or formation of the composite material. Such other suitable thermoplastic resins will generally be apparent to the skilled artisan.

Fibers suitable for use in the invention include glass fibers, carbon fibers, synthetic organic fibers, particularly high modulus organic fibers such as para- and meta-aramid fibers, nylon fibers, polyester fibers, or any of the thermoplastic resins mentioned above that are suitable for use as fibers, natural fibers such as hemp, sisal, jute, and cellulosic fibers, mineral fibers such as basalt, mineral wool (e.g., rock or slag wool), wollastonite, alumina silica, and the like, or mixtures thereof, metal fibers, ceramic fibers, or mixtures thereof. The fiber content in the thermoplastic core is from about 15% to about 65%, more particularly from about 45% to about 60%, by weight of the thermoplastic core. Fibers suitable for use herein are further described in the patent literature (as noted herein), provided the length and diameter dimensions are in the ranges noted above.

The fibers dispersed within the thermoplastic resin, forming the thermoplastic core of the composite material, generally have a diameter of from about 17 μm to about 22 μm, and a length of from about 17 mm to about 25 mm; more particularly, the fiber diameter is from about 18.5 μm to about 21 μm and the fiber length is from about 18.5 mm to about 22 mm.

The composite material may generally be prepared in various forms, such as sheets or films, as layered materials on pre-formed substrates, or in other more rigid forms depending on the particular application need. For certain applications, the composite material is provided in sheet form and may optionally include one or more additional layers on one or both surfaces of such a sheet. Without limitation, such surface or skin layers may be, e.g., a film, non-woven scrim, a veil, a woven fabric, or a combination thereof. The skin or surface layer may be desirably air permeable and can substantially stretch and spread with the fiber-containing composite sheet during thermoforming and/or molding operations. In addition, such layers may be adhesive, such as a thermoplastic material (e.g., an ethylene acrylic acid copolymer or other such polymers) applied to the surface of the fiber-containing thermoplastic material. Generally, the areal density of the composite material, particularly when in sheet form, varies from about 400 g/m² to about 4000 g/m². In further aspects of the invention, the composite material may be prepared in the form of a fiber-reinforced tape, such as a unidirectional tape.

The composite material of the invention may be used to form various intermediate and final form articles, including construction articles or articles for use in automotive applications, including, without limitation, a parcel shelf, package tray, headliner, door module, instrument panel topper, side wall panels such as for recreational vehicles, cargo liners, front and/or rear pillar trim, a sunshade, and the like. Other such articles will be apparent to the skilled artisan. The composite material can be molded into various articles using methods known in the art, for example, pressure forming, thermal forming, thermal stamping, vacuum forming, compression forming, and autoclaving.

As described herein, the invention also relates to a method of providing a composite material having an improved combination of flexural stiffness, peak load, offset yield and loft properties. Generally, the method includes the steps of adding reinforcing fibers and thermoplastic resin as described above to an agitated liquid-containing foam to form a dispersed mixture of resin and fibers. The mixture is then coated onto a forming support element and the liquid is evacuated to form a web. The web is next heated above the softening temperature of the thermoplastic resin and compressed to a predetermined thickness to form the composite material. Notably, the method provides a composite material that exhibits improved maximum flexural stiffness at reduced basis weight compared to a comparative composite material comprising a fiber reinforced thermoplastic core differing from the composite material only in that the fiber reinforced thermoplastic core of the comparative composite material does not contain fibers meeting all of the content, diameter and length conditions of the fibers in the thermoplastic core of the composite material. Additional steps may also be utilized in the inventive method, such as the inclusion of appropriate steps to provide one or more surface or skin layers to the composite material. It should also be noted that while the method provides an improved combination of flexural stiffness, peak load, offset yield and loft properties, it is not necessary that all of these characteristics be individually improved compared with a comparative composite material. While improvement in each of these characteristics is certainly desirable, for the purposes described herein, an improved combination results if one, more than one, or all of these characteristics is or are improved relative to the comparative composite material.

As the thermoplastic resin containing dispersed fibers, the composite material of the invention may, according to one embodiment, include a low density glass mat thermoplastic composite (GMT). One such mat is prepared by AZDEL, Inc. and sold under the trademark SUPERLITE® mat. Preferably, the areal density of the such a GMT is from about 400 grams per square meter of the GMT (g/m²) to about 4000 g/m², although the areal density may be less than 400 g/m² or greater than 4000 g/m² depending on the specific application needs. Preferably, the upper density should be less than about 4000 g/m².

The SUPERLITE® mat is generally prepared using chopped glass fibers, a thermoplastic resin and a thermoplastic polymer film or films and or woven or non-woven fabrics made with glass fibers or thermoplastic resin fibers such as polypropylene (PP), polybutylene terephthalate (PBT), polyethylene terephthalate (PET), polycarbonate (PC), a blend of PC/PBT, or a blend of PC/PET. Generally, PP, PBT, PET, and PC/PET and PC/PBT blends are the preferred thermoplastic resins. To produce the low density GMT, the materials and other additives are metered into a dispersing foam contained in an open top mixing tank fitted with an impeller. The foam aides in dispersing the glass fibers and thermoplastic resin binder. The dispersed mixture of glass and thermoplastic resin is pumped to a head-box located above a wire section of a paper machine via a distribution manifold. The foam, not the glass fiber or thermoplastic resin, is then removed as the dispersed mixture passes through a moving wire screen using a vacuum, continuously producing a uniform, fibrous wet web. The wet web is passed through a dryer to reduce moisture content and to melt the thermoplastic resin. When the hot web comes out of the dryer, a thermoplastic film may be laminated into the web by passing the web of glass fiber, thermoplastic resin and thermoplastic polymer film or films through the nip of a set of heated rollers. A non-woven and/or woven fabric layer may also be attached along with or in place thermoplastic film to one side or to both sides of the web to facilitate ease of handling the glass fiber-reinforced mat. The SUPERLITE® composite is then passed through tension rolls and continuously cut (guillotined) into the desired size for later forming into an end product article. Further information concerning the preparation of such GMT composites, including suitable materials used in forming such composites that may also be utilized in the present invention, may be found in a number of U.S. patents, e.g., U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US 2005/0228108, US 2005/0217932, US 2005/0215698, US 2005/0164023, and US 2005/0161865.

Natural (e.g., hemp, sisal) and/or synthetic fibers such as glass fibers, carbon fibers, organic fibers such as para- and meta-polyaramids, polyesters such as polyethylene terephthalate fibers, and mineral fibers such as basalt fibers may also be used for the production (as described above) of such a mat for use in the composite material of the invention. Also, various amorphous or crystalline thermoplastic resins may be employed such as polyesters (PET, PBT, PPT), acrylics, HDPE, polyethylene (PET), polypropylene (PP), polycarbonate (PC) or blends of PC/PBT or PC/PET and the like thermoplastic polymers without modification of the web forming process. The ratio of fibers to polymers, as well as the basic weight of the web, can be varied in order to meet the particular requirements of cost and material performance of a specific application.

Mineral fibers suitable for use in such mats generally include, without limitation, any mineral fiber that provides the advantages demonstrated herein. Such fibers include, without limitation, basalt, mineral wool (e.g., rock or slag wool), wollastonite, alumina silica, and the like, or mixtures thereof. Other fibers may also be incorporated in such mats if desired, including glass fibers, carbon fibers, synthetic organic fibers, particularly high modulus organic fibers such as para- and meta-aramid fibers, natural fibers such as hemp and sisal, or mixtures thereof. As noted above, suitable fiber contents range from about 15% to about 65% by weight of the thermoplastic core. Such other fibers suitable for use herein are also further described in the patent literature (as noted below), and have fiber dimensions as described above.

The mat, preferably a low density glass mat (GMT) composite, may be desirably formed into an article by a forming technique such as compression molding or thermoforming, using air or gas pressure as an assist, if desired. Such methods are well known and described in the literature, e.g., see U.S. Pat. Nos. 6,923,494 and 5,601,679. Thermoforming methods and tools are also described in detail in DuBois and Pribble's “Plastics Mold Engineering Handbook”, Fifth Edition, 1995, pages 468 to 498.

Additional information concerning suitable thermoplastic resins and fibers, as well as details concerning wet-laid manufacturing methods useful in the present invention, may be found in U.S. Pat. Nos. 5,981,046 and 6,756,099.

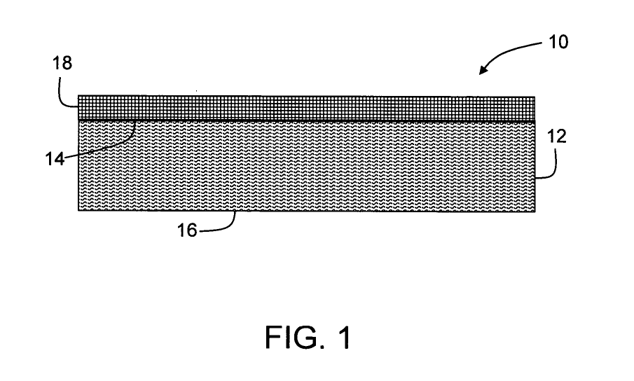

A cross sectional schematic illustration of an exemplary composite thermoplastic sheet 10 is shown in FIG. 1 in which a porous core 12 has a first surface 14 and a second surface 16. A decorative skin 18 can optionally be bonded to first surface 14. In alternate embodiments, skins and/or barrier layers may optionally be bonded to first surface 14 and/or second surface 16.

Core 12 in FIG. 1 may be formed from a web made up of open cell structures formed by random crossing over of reinforcing fibers held together, at least in part, by one or more thermoplastic resins. In general, the void content of porous core 12 ranges between about 0% and about 95%, more particularly between about 30% and about 80% of the total volume of core 12. Porous core 12 may also be made up of open cell structures formed by random crossing over of reinforcing fibers held together, at least in part, by one or more thermoplastic resins, where about 40% to about 100% of the cell structure is open, thereby allowing for the flow of air and other gases through the core. Core 12 has a density in one embodiment of about 0.1 gm/cc to about 1.8 gm/cc, more particularly about 0.3 gm/cc to about 1.0 gm/cc. Core 12 may be formed using known manufacturing process, for example, a wet laid process, an air laid process, a dry blend process, a carding and needle process, and other known process that are employed for making non-woven products. Combinations of such manufacturing processes are also useful.

Core 12 includes about 15% to about 65% by weight of reinforcing fibers having an average length of between about 17 mm and about 25 mm and a diameter of about 17 μm to about 22 μm, and about 35% to about 85% by weight of a wholly or substantially unconsolidated fibrous or particulate thermoplastic materials, where the weight percentages are based on the total weight of core 12. In another aspect, core 12 includes about 50% to about 60% by weight of reinforcing fibers. In a further aspect, core 12 includes reinforcing fibers having an average length of about 18.5 mm to about 21 mm and a diameter of about 18.5 μm to about 20 μm. Suitable reinforcing fibers include any of the fibers mentioned herein, including glass fibers, basalt fibers, and mixtures thereof.

In one representative embodiment, the composite material shown in FIG. 1 may be made by adding reinforcing fibers having an average length of about 17 mm to about 25 mm and thermoplastic powder particles, for example polypropylene powder, to an agitated aqueous foam. The components are then agitated for a sufficient time to form a dispersed mixture of the reinforcing fibers and thermoplastic powder in the aqueous foam. The dispersed mixture is then laid down on any suitable support structure, for example, a wire mesh, and the water is evacuated through the support structure forming a web. The web is next dried and heated above the softening temperature of the thermoplastic powder. The web is then cooled and pressed to a predetermined thickness to produce a composite sheet having a void content of between about 0% to about 95%. In an alternate embodiment, a binder material is applied to the web and a vacuum is applied to infuse the binder material through the web before heating and pressing the web. In one embodiment, the binder material is a water emulsion of a low molecular weight polyolefin, for example polypropylene. The binder may also include a silane coupling agent, for example, aminopropyltriethoxysilane, and a de-foaming agent.

The web is heated above the softening temperature of the thermoplastic resins on core 12 to substantially soften the plastic materials and is passed through one or more consolidation devices, for example calendaring rolls, double belt laminators, indexing presses, multiple daylight presses, autoclaves, and other such devices used for lamination and consolidation of sheets and fabrics so that the plastic material can flow and wet out the fibers. The gap between the consolidating elements in the consolidation devices are set to a dimension less than that of the unconsolidated web and greater than that of the web if it were to be fully consolidated, thus allowing the web to expand and remain substantially permeable after passing through the rollers. For example, the gap may be set to a dimension about 5% to about 10% greater than that of the web if it were to be fully consolidated. A fully consolidated web means a web that is fully compressed and substantially void free; i.e., having less than 5% void content and negligible open cell structure.

Particulate plastic materials including short plastics fibers can also be included to enhance the cohesion of the web structure during manufacture. Bonding is affected by utilizing the thermal characteristics of the plastic materials within the web structure; i.e., the web structure is heated sufficiently to cause the thermoplastic component to fuse at its surfaces to adjacent particles and fibers.

It is to be understood that while the invention has been described in conjunction with certain specific embodiments thereof, that the foregoing description as well as the examples that follow are intended to illustrate and not limit the scope of the invention. Other aspects, advantages and modifications within the scope of the invention will be apparent to those skilled in the art to which the invention pertains.

All patents, patent applications, and publications mentioned herein are hereby incorporated by reference in their entireties.

### EXPERIMENTAL

Porous composite sheets were prepared using the wet-lay papermaking process (as described and referenced herein) containing finely dispersed filamentized chopped fibers having nominal diameters ranging from 16 μm to 19 μm and chopped fiber lengths from 0.25 inch to 1 inch and polypropylene resin uniformly distributed through the thickness of the composite sheets. Representative inventive glass fiber-filled sheets were prepared using fibers having a diameter of 19 μm and 0.75 in. length. Comparative sample sheets containing 16 μm, 0.5 in. glass fibers were also prepared.

The composite sheets were laminated using a pair of nip rollers, with a polyethylene scrim layer on both sides. An adhesive layer of an ethylene acrylic acid copolymer (EAA) was used on both sides between the scrim layers and the fiber-filled composite sheet materials.

Sample specimens were evaluated for flexural properties including maximum stiffness, and loft characteristics at various fiber loadings ranging from 45 to 60% by weight of the thermoplastic core.

After the sheet samples were prepared, flex bars (50×150 mm) were cut out in the machine direction and cross-machine direction (MD and CD, respectively) and tested according to the Honda Motor Co. test method three-point bending test. Specimen thickness was nominally 2.9-3.0 mm. The specimens were supported for loading by placing them on rounded supports spaced 100 mm apart and were loaded at a constant crosshead speed of 50 mm/min at the centerpoint of the specimen. The stress/strain data were recorded as the load was applied, along with the peak load at break. The modulus was determined as the slope from the linear portion of the stress/strain curve in a conventional manner. The data were then evaluated for the geometrical mean values of flex strength, flex modulus and maximum stiffness (calculated), free loft and loftability factor responses were entered into a Design Expert-Stat Ease computer program for analysis along with the required factors (fiber length, fiber diameter, fiber %, weight). The geometrical mean (GeoMean) values were used to normalize the results. The geometrical mean was calculated using the following relationship:

$$Geometrical Mean = \sqrt{( MD value ) \times ( CD value )}$$

The maximum stiffness values were calculated using the following equation:

$$Max Stiffness = Measured Stiffness \times {[ ( \frac{0.586 \times Free Loft}{Measured Thickness} ) ]}^{\frac{1752}{GSM}}$$

### EXAMPLE 1 AND COMPARATIVE EXAMPLE 1A

### Maximum Stiffness Measurements

Composite samples were prepared as described above containing nominal 19 μm diameter glass fibers at 0.25 in. and 0.5 in. fiber length in sheet form at a fiber loading content of 60 wt. % dispersed in a polypropylene resin. Comparative samples were evaluated for 13 μm and 16 μm diameter glass fibers at 0.25 in., 0.5 in., 0.75 in., and 1.0 in. fiber length. Comparative sheet samples were prepared as described above containing nominal 0.5 in. length, 16 μm diameter glass fibers (comparative example 1A) in polypropylene resin at a fiber loading content of 55 wt. %. The total gsm values for the glass-filled sheets ranged from approximately 600 gsm to 1400 gsm.

Composite sheet samples were prepared for specimen preparation by: trimming samples to 12 in.×12 in. plaques, labeling and marking machine directionality; lofting the plaques for 2.5 minutes at about 200° C. in a convection oven; removing the plaques and transferring to a cold/room temperature press for complete consolidation; permitting the plaque to rest, and then relofting for 2.5 minutes at about 200° C. in the convection oven; and, transferring the plaque to the cold press and molding the plaque to 5 times the calculated theoretical consolidated thickness (or measured thickness after the first compression consolidation of the plaque).

The calculated theoretical consolidated thickness was determined based on the theoretical consolidated density and material weight:

$$Theoretical Consolidated Density = \frac{1}{( \frac{glass fraction}{glass density} ) + ( \frac{resin fraction}{resin density} )}$$

$$Theoretical Consolidated Thickness = ( \frac{1}{Theoretical Consolidated Density} ) \times ( \frac{GSM}{1000} )$$

The loftability factor was also calculated showing how many times the consolidated thickness the material can expand. Such information is useful when materials are compared over a range of weights because the void percentage remains constant.

$$Loftability Factor = \frac{Measured Free Loft ( mm )}{Theoretical Consolidated Thickness}$$

Free loft measurements were also taken on 4 inch diameter disk samples after the first lofting step that were ashed (burning off of the resin) to determine glass and resin percentages. Several measurements taken around the circumference of the disk were used to determine the average.

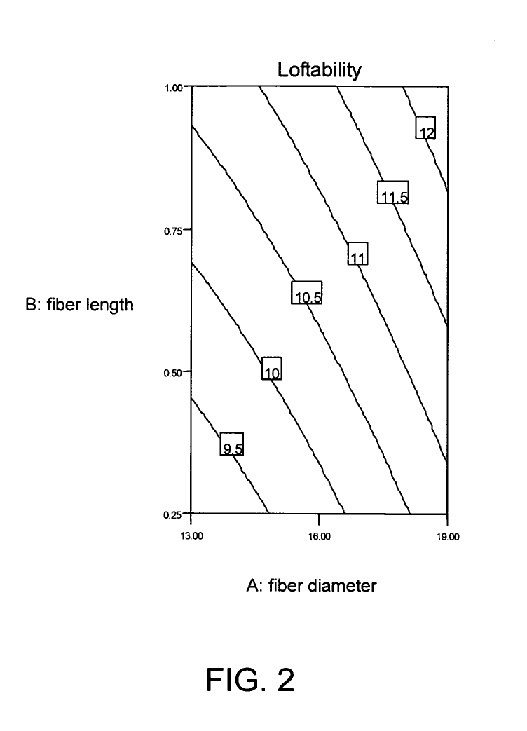

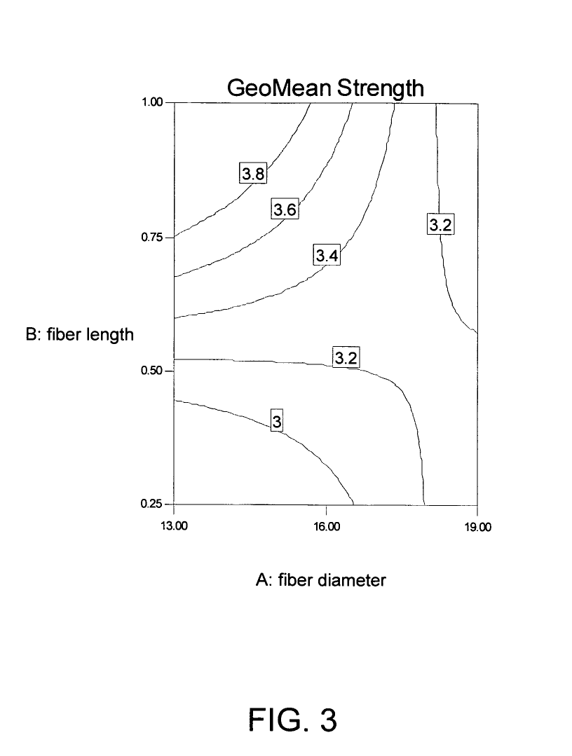

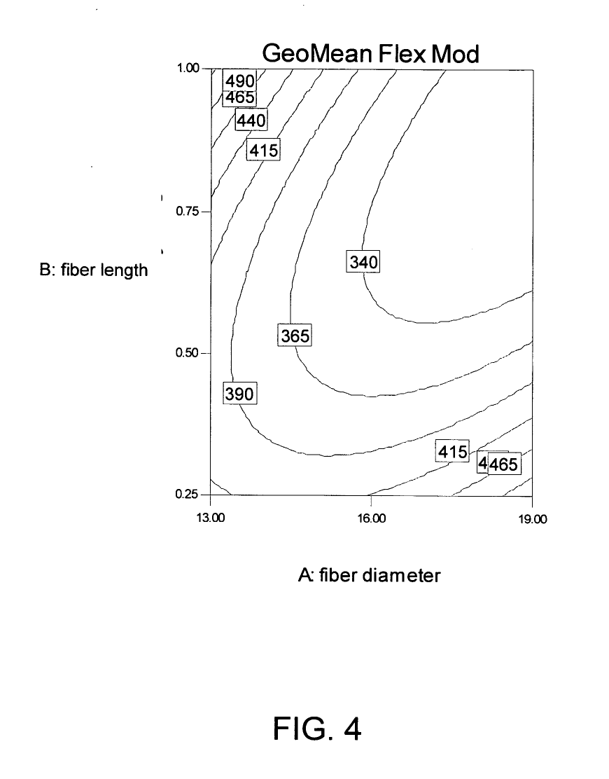

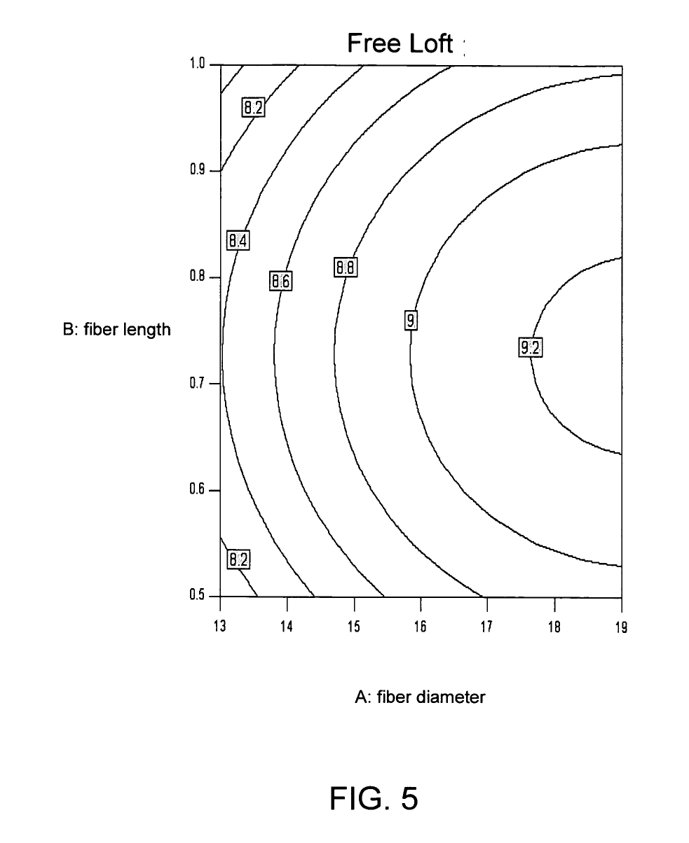

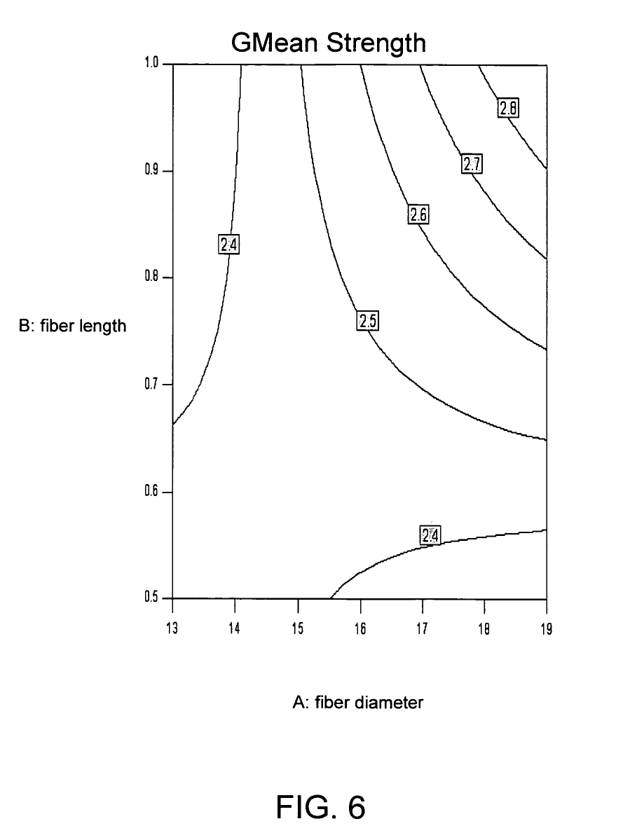

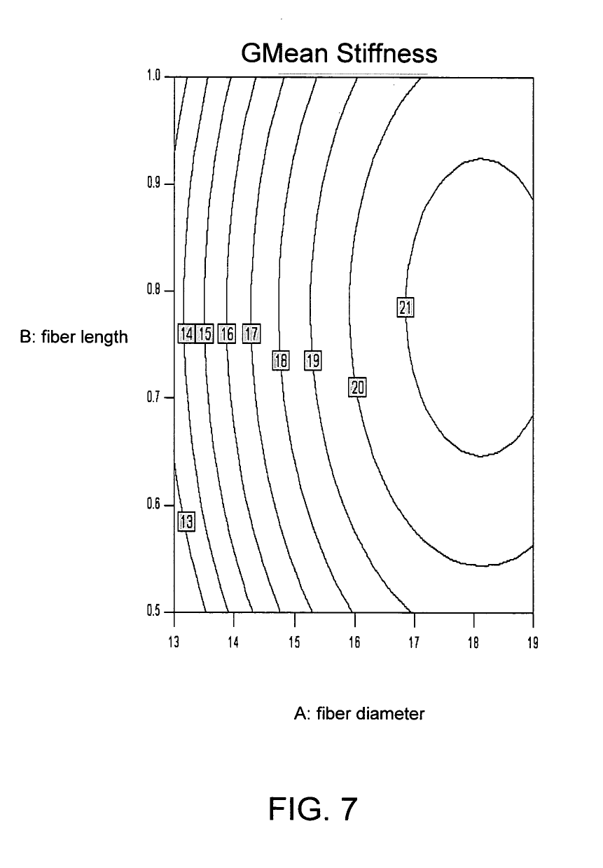

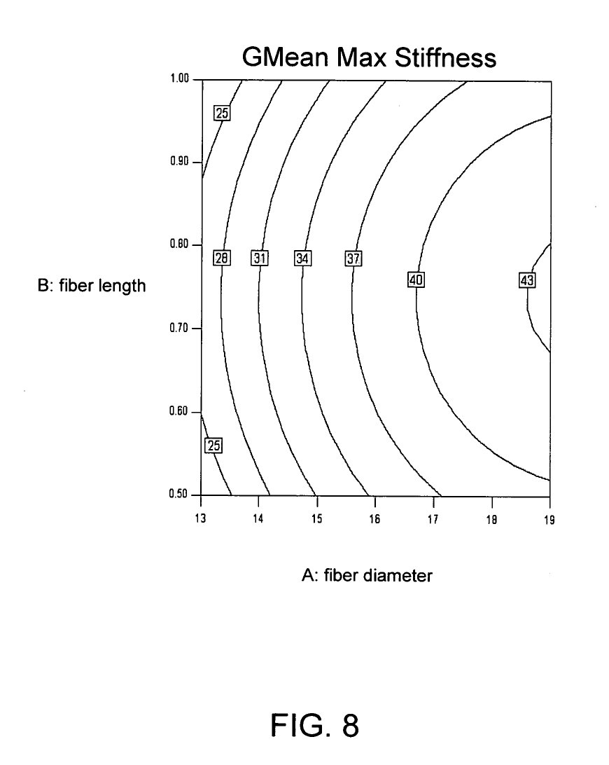

The flexural properties (strength and modulus) and loftability results were analyzed with the aid of the Design Expert-Stat Ease computer program noted above, using an analysis of variance, resulting in the development of a model and contour plots over the entire parameter space for each of the material properties, as shown in FIGS. 2-7. A plot of the calculated geomean maximum stiffness is shown in FIG. 8. The contour plots are model predictions based on an analysis of the data. The model fit, R² values, are shown in Table 1 for each of the composite material responses in comparison to the experimental data.

TABLE 1

| | | | | | | | | Adj | Pred | Lack |
|---|---|---|---|---|---|---|---|---|---|---|
| Response | Min | Max | Transform | Model | DF | F-value | R² | R² | R² | of Fit |
| Free Loft | 4.2 | 8.1 | none | R quadratic | 8 | 790 | 0.964 | 0.963 | 0.961 | none |
| Loftability | 6.4 | 14.9 | none | R quadratic | 7 | 974 | 0.966 | 0.965 | 0.964 | none |
| Factor | | | | | | | | | | |
| Flex | 1.3 | 3.7 | none | R quadratic | 8 | 49 | 0.618 | 0.605 | 0.589 | 5.73 |
| Strength | | | | | | | | | | |
| Stiffness | 1.4 | 45.9 | none | R quadratic | 8 | 492 | 0.943 | 0.941 | 0.938 | 4.33 |
| Max | 5.6 | 50.3 | none | R quadratic | 7 | 307 | 0.899 | 0.896 | 0.893 | 5.73 |
| Stiffness | | | | | | | | | | |

From FIGS. 2-7, the following general relationships may be noted:
the Loftability Factor was positively influenced by glass fiber percentage and longer fibers with larger diameters;
the GeoMean Flex Strength appeared to be positively affected by increasing fiber length for 13 μm and 16 μm diameter fibers; and
the GeoMean Flex Modulus values were highest for sheets having 13 μm diameter and 1 in. fibers and 19 μm diameter and 0.25 in. fibers.

Flexural and loft characteristics for Example 1 and Comparative Example 1 A are shown in Table 2:

TABLE 2

| Parameter | Example 1 | Example 1A |
|---|---|---|
| Fiber Diameter (μm) | 19 | 16 |
| Fiber Length (mm) | 19 | 13 |
| Fiber Content | 60 | 55 |
| Basis Weight (gsm) | 650 | 800 |
| Free Loft (mm) | 6.7 | 6.6 |
| Max. Stiffness (N/cm) | 31.6 | 23.4 |

From Table 2, it should be noted that Example 1 has a maximum stiffness that is about 35% higher than the composite thermoplastic sheet of Example 1A. A decrease in basis weight of about 18% is also demonstrated for Example 1 compared to the composite sheet of Example 1A.

### EXAMPLE 2 AND COMPARATIVE EXAMPLE 2A

### Flexural Property Measurements

Composite sheet samples were prepared as described above containing nominal 0.75 inch length, 19 μm diameter glass fibers (example 2) in polypropylene resin at a fiber loading content of 50 wt. %. Comparative sheet samples were also prepared as described above containing nominal 0.5 inch length, 16 μm diameter glass fibers (comparative Example 2A) in polypropylene resin at a fiber loading content of 55 wt. %. Results for Example 2 and Comparative Example 2A are summarized in Table 3:

TABLE 3

| Parameter | Example 2 | Example 2A |
|---|---|---|
| Fiber Diameter (μm) | 19 | 16 |
| Fiber Length (mm) | 19 | 13 |
| Fiber Content | 50 | 55 |
| Core Basis Weight (gsm) | 850 | 1000 |
| Peak Load (N) | 19.8 | 22.7 |
| Yield Offset Strength (N) | 16.7 | 17.8 |
| Stiffness (N/mm) | 2.4 | 2.38 |

As may be seen from Table 3, Example 2 has mechanical properties that are comparable to the composite thermoplastic sheet of Example 2A, while also exhibiting a 15% reduction in the basis weight.

While the invention has been described in terms of various specific embodiments, those skilled in the art will recognize that the invention can be practiced with modification within the spirit and scope of the claims.

What is claimed is:

1. A fiber reinforced thermoplastic composite material comprising a fiber reinforced thermoplastic core comprising
a thermoplastic resin and
discontinuous fibers dispersed within the thermoplastic resin satisfying the following conditions: a content of about 15 wt. % to about 65 wt. % of the thermoplastic core, a diameter of from about 17 μm to about 22 μm, and a length of from about 17 mm to about 25 mm,
wherein, the composite material exhibits improved maximum flexural stiffness at reduced basis weight compared to a comparative composite material comprising a fiber reinforced thermoplastic core differing from the composite material only in that the fiber reinforced thermoplastic core of the comparative composite material does not contain fibers meeting all of the content, diameter and length conditions of the fibers in the thermoplastic core of the composite material.

2. The composite material of claim 1, wherein the maximum flexural stiffness is at least about 20% greater than the comparative composite material.

3. The composite material of claim 1, wherein the maximum flexural stiffness is at least about 35% greater than the comparative composite material.

4. The composite material of claim 1, wherein the reduced basis weight of the composite material is at least about 10% less than the comparative composite material.

5. The composite material of claim 1, wherein the composite material further has flexural peak load and yield offset values at reduced basis weight that are about the same as or greater than the comparative composite material.

6. The composite material of claim 1, wherein the thermoplastic core has a porosity between about 0% to about 95% by volume of the thermoplastic core and an areal density of from about 400 g/m² to about 4000 g/m².

7. The composite material of claim 6, wherein the thermoplastic core has a porosity between about 30% to about 80% by volume of the thermoplastic core.

8. The composite material of claim 1, wherein the fiber content is from about 45 wt. % to about 60 wt. % of the thermoplastic core.

9. The composite material of claim 1, wherein the fiber diameter is from about 18.5 μm to about 21 μm.

10. The composite material of claim 1, wherein the fiber length is from about 18.5 mm to about 22 mm.

11. The composite material of claim 1, wherein the thermoplastic resin is selected from polyolefins, thermoplastic polyolefin blends, polyvinyl chloride, butadiene polymers, polyamides, polyesters, polycarbonates, polyestercarbonates, polystyrenes, acrylonitrylstyrene polymers, acrylonitrile-butylacrylate-styrene polymers, polyether imide, polyphenylene ether, polyphenylene oxide and copolymers or mixtures thereof.

12. The composite material of claim 1, wherein the fibers are selected from glass fibers, carbon fibers, synthetic organic fibers, natural fibers, mineral fibers, metal fibers, ceramic fibers, or mixtures thereof.

13. The composite material of claim 1, further comprising a skin layer selected from films, non-woven scrims, veils, woven fabrics, or a combination thereof.

14. An article formed from the composite material of claim 1, in the form of a construction article, tape, or an automobile article selected from a parcel shelf, package tray, headliner, door module, instrument panel topper, side wall panels, cargo liners, front and/or rear pillar trim, or a sunshade.

15. The composite material of claim 1, prepared by a method of providing a composite material comprising,
adding reinforcing fibers and a thermoplastic resin to an agitated liquid-containing foam to form a dispersed mixture of thermoplastic resin and reinforcing fibers, wherein the fiber content is from about 15 wt. % to about 65 wt. % of the thermoplastic core, and the fibers have a diameter of from about 17 μm to about 22 μm, and a length of from about 17 mm to about 25 mm;
coating the dispersed mixture of reinforcing fibers and thermoplastic resin onto a forming support element;
evacuating the liquid to form a web;
heating the web above the softening temperature of the thermoplastic resin; and
compressing the web to a predetermined thickness to form the thermoplastic core of the composite material.

16. In a composite material comprising a fiber reinforced thermoplastic core comprising a thermoplastic resin and discontinuous fibers dispersed within the thermoplastic resin, the improvement comprising providing improved maximum flexural stiffness at reduced basis weight by including fibers in the thermoplastic core satisfying the following conditions: a content of about 15 wt. % to about 65 wt. % of the thermoplastic core, a diameter of from about 17 μm to about 22 μm, and a length of from about 17 mm to about 25 mm, compared to a comparative composite material comprising a fiber reinforced thermoplastic core differing from the composite material only in that the fiber reinforced thermoplastic core of the comparative composite material does not contain fibers meeting all of the content, diameter and length conditions of the fibers in the thermoplastic core of the composite material.

17. The composite sheet material of claim 16, wherein the maximum flexural stiffness is at least about 20% greater than the comparative composite material.

18. The composite sheet material of claim 16, wherein the reduced basis weight of the composite material is at least about 10% less than the comparative composite material.

19. The composite sheet material of claim 16, wherein the composite material further has flexural peak load and yield offset values at reduced basis weight that are about the same as or greater than the comparative composite material.

20. A method of providing a composite material comprising a thermoplastic core and having an improved combination of flexural stiffness, peak load, offset yield and loft properties, the method comprising
adding reinforcing fibers and thermoplastic resin to an agitated liquid-containing foam to form a dispersed mixture of thermoplastic resin and reinforcing fibers, wherein the fiber content is from about 15 wt. % to about 65 wt. % of the thermoplastic core formed from the reinforcing fibers and the thermoplastic resin, and the fibers have a diameter of from about 17 μm to about 22 μm, and a length of from about 17 mm to about 25 mm;
coating the dispersed mixture of reinforcing fibers and thermoplastic resin onto a forming support element;
evacuating the liquid to form a web;
heating the web above the softening temperature of the thermoplastic resin; and
compressing the web to a predetermined thickness to form the thermoplastic core of the composite material,
wherein, the composite material exhibits improved maximum flexural stiffness at reduced basis weight compared to a comparative composite material comprising a fiber reinforced thermoplastic core differing from the composite material only in that the fiber reinforced thermoplastic core of the comparative composite material does not contain fibers meeting all of the content, diameter and length conditions of the fibers in the thermoplastic core of the composite material.

21. The method of claim 20, wherein the maximum flexural stiffness is at least about 20% greater than the comparative composite material.

22. The method of claim 20, wherein the reduced basis weight is at least about 10% less than the comparative composite material.

23. The method of claim 20, wherein the composite material further has flexural peak load and yield offset values at reduced basis weight that are about the same as or greater than the comparative composite material.

24. A composite material prepared by the method of claim 20.

25. An article formed from the composite material of claim 24, in the form of a construction article, tape, or an automobile article selected from a parcel shelf, package tray, headliner, door module, instrument panel topper, side wall panels, cargo liners, front and/or rear pillar trim, or a sunshade.
